(19) United States
(12) Patent Application Publication
(10) Pub. No.: US 2007/0235345 A1
(43) Pub. Date: Oct. 11, 2007

(54) Polishing method that suppresses hillock formation

(75) Inventors: Tianbao Du, Santa Clara, CA (US); Feng Q. Liu, San Jose, CA (US); May Yu, Fremont, CA (US); Alan Duboust, Sunnyvale, CA (US); Wei-Yung Hsu, Santa Clara, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/400,454

(22) Filed: Apr. 7, 2006

(51) Int. Cl. B23H 5/08

(52) U.S. Cl. 205/663

(57) ABSTRACT

An ECMP method that suppresses hillock formation on a substrate includes the step of buffing a substrate before a two-step electrochemical mechanical polishing process. The buffing step prevents hillocks from forming around the features of the substrate and does not interfere with the protrusion formation. The buffing step includes contacting the substrate with a polishing pad and rotating the substrate and the polishing pad in opposite directions.

### BACKGROUND OF THE INVENTION

1. Field of the Invention

Embodiments of the present invention generally relate to methods of electrochemical mechanical polishing (ECMP) to avoid hillock formation.

2. Description of the Related Art

Chemical mechanical polishing (CMP) is a common technique used to planarize substrates. In conventional CMP techniques, a substrate carrier or polishing head is mounted on a carrier assembly and positioned to be in contact with a polishing article in a CMP apparatus. The carrier assembly provides a controllable pressure to the substrate urging the substrate against the polishing article. The article is moved relative to the substrate by an external driving force. Thus, the CMP apparatus effects polishing or rubbing movement between the surface of the substrate and the polishing article while dispersing a polishing composition to effect both chemical activity and mechanical activity. Electrochemical mechanical polishing (ECMP) is a CMP technique in which an electrical current is provided to enhance material removal.

Sometimes, ECMP will not create a sufficiently planar surface. Dishing can occur over wide area features on a substrate. Dishing is a condition where the conductive material within the substrate features is partially removed. More conductive material is removed from the center of the feature so that the surface of the conductive features resembles a dish rather than a planar surface. To prevent dishing, protrusions can be formed during ECMP. A protrusion can be formed by removing the conductive material over the desired feature (usually the wide area feature) at a lower rate than at all other locations across the substrate. An exemplary method of forming a protrusion is discussed in U.S. patent application Ser. No. 11/356,352, filed Feb. 15, 2006, entitled “Method and Composition for Polishing a Substrate” by Liu et al., which is hereby incorporated by reference in its entirety. The protrusions will be formed over any wide area features on the substrate. The protrusions help to create a more uniform surface after polishing. Unfortunately, even the protrusions cannot always prevent a surface from being undesirably rough after polishing.

Hillocks can form across the surface of the conductive layer during polishing. Hillocks are little, undesired protrusions that extend from the conductive layer surface. Hillocks are typically a few hundred angstroms in height. A hillock extending above the conductive surface will cause uneven planarization so that valleys will form across the planarized surface rather than a uniformly smooth surface.

The substrate 5 in FIG. 1A has been through a first polishing step. As can be seen from FIG. 1A, the substrate 5 has wide feature dimensions 30 and narrow feature dimensions 20 formed in a dielectric layer 10 that is lined with a barrier layer 40 and filled with conductive material 60. A protrusion 65 has been formed over the wide feature dimension 30 as desired, but hillocks 63 are present on the surface of the conductive material 60.

As the polishing proceeds through a second polishing step, the conductive material 60 is removed and the protrusion 45 is now smaller so that the edge of the protrusion is at the level of the barrier layer 40, but the hillocks 63 have now caused valleys 43 to form in the barrier layer 40 (see FIG. 1B). Once the second polishing step is completed, the wide feature definition 30 and the narrow feature definitions 20 are generally smooth, but there are numerous valleys 13 within the substrate (see FIG. 1C). The valleys 13 are undesirable and negatively affect semiconductor device performance.

Therefore, there is a need in the art for a process of planarizing a substrate without having undesirable hillocks on a substrate.

### SUMMARY OF THE INVENTION

The present invention involves planarizing a substrate using ECMP. By cleaning and buffing the substrate prior to polishing, hillocks will not form. Additionally, any protrusions purposefully formed over wide features on the substrate will not be adversely affected.

A polishing method that suppresses hillock formation according to various embodiments of the present invention involves buffing a substrate and electrochemical mechanical polishing the buffed substrate. The buffing according to a first embodiment comprises contacting the substrate and the polishing pad, rotating the substrate, and rotating the polishing pad. The polishing pad and the substrate are rotated in opposite directions.

The buffing according to a second embodiment comprises contacting the substrate and the polishing pad, rotating the substrate, rotating the polishing pad, and moving the substrate in a sinusoidal pattern across the polishing pad while both the polishing pad and the substrate rotate. The polishing pad and the substrate are rotated in opposite directions.

The buffing according to a third embodiment comprises contacting the substrate and the polishing pad, rotating the substrate, rotating the polishing pad, providing deionized water between the polishing pad and the substrate, and moving the substrate in a sinusoidal pattern across the polishing pad while both the polishing pad and the substrate rotate. The polishing pad and the substrate are rotated in opposite directions. The substrate and the polishing pad are rotated at about 75 RPM to about 85 RPM, and the downward pressure is about 0.5 psi to about 0.9 psi. The polishing pad used for the electrochemical mechanical polishing may be different from the polishing pad used for the buffing.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1C show a prior art substrate at various stages of processing that has not been cleaned and buffed prior to polishing.

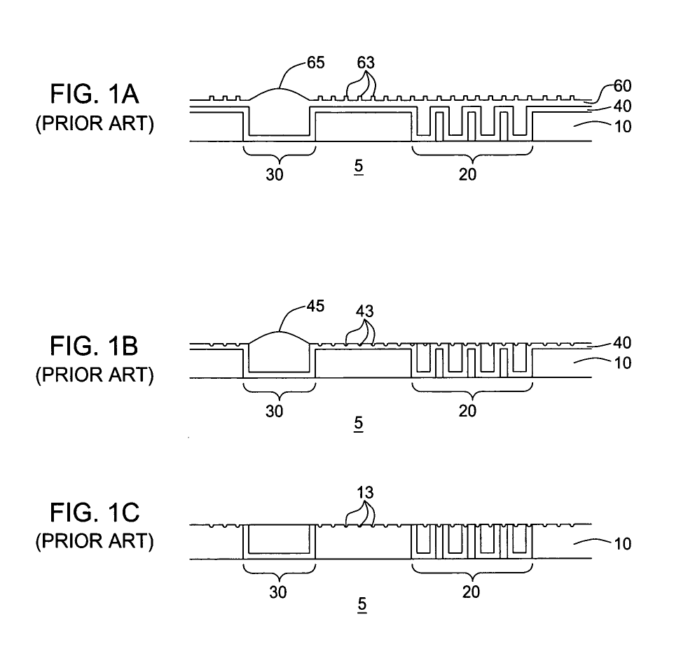

FIGS. 2A-2F show a substrate at various stages of processing.

### DETAILED DESCRIPTION

The present invention involves suppressing hillock formation when planarizing a substrate using ECMP. An exemplary apparatus in which the invention can be practiced is the REFLEXION LK ECMP™ system produced by Applied Materials, Inc. of Santa Clara, Calif. Other planarizing modules, including those that use processing pads, planarizing webs, or a combination thereof, and those that move a substrate relative to a planarizing surface in a rotational, linear or other planar motion may also be adapted to benefit from the invention.

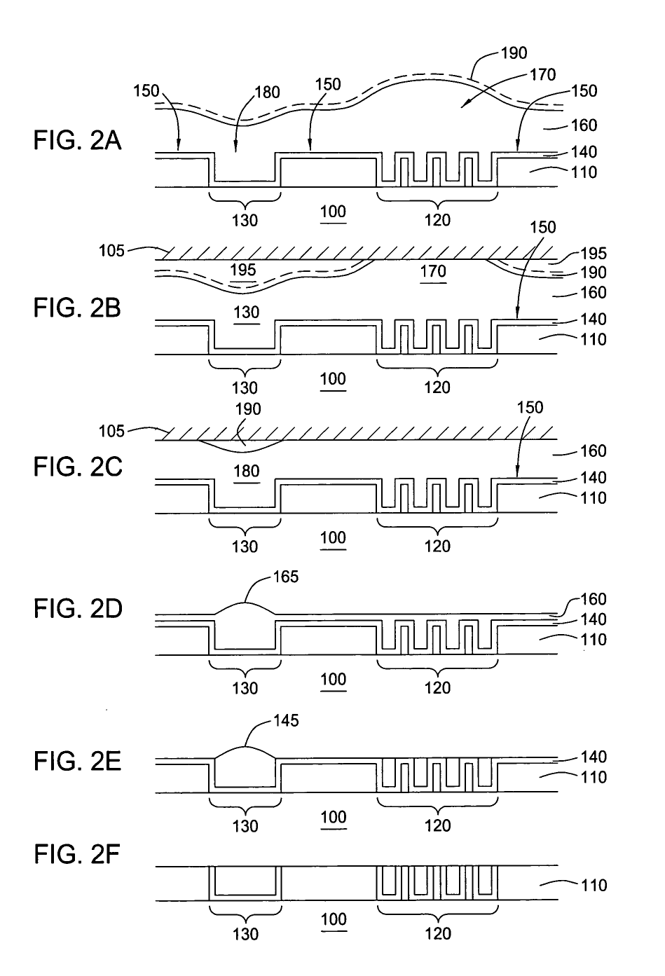

FIG. 2A shows an exemplary substrate 100 that can be processed according to embodiments of the present invention. The substrate 100 can be any substrate, but substrates suitable for use in semiconductor processing are particularly preferred. Examples of suitable substrate materials include silicon, germanium, and silicon germanium.

A dielectric layer 110 is first deposited over the substrate 100. The dielectric layer 110 can be any conventional dielectric material useful in semiconductor processing. Particularly useful dielectric material can be found the Liu et al. patent application discussed above.

Within the dielectric layer 110, narrow feature definitions 120 and wide feature definitions 130 are formed. The terms wide and narrow feature definitions are relative to device size. For example, wide feature definitions are currently considered to be greater than about 2 microns in width or size and narrow feature definitions are considered to be less than or equal to about 2 microns. The invention contemplates the processes described herein being applied to the relative wide and narrow feature definitions for various device sizes.

A barrier layer 140 is deposited over the substrate 100 (i.e., on the substrate field 150) and within both the narrow feature definitions 120 and the wide feature definitions 130. The barrier layer can be formed of conventionally utilized barrier layer materials such as nitrides containing tantalum, titanium, or tungsten. Particularly useful barrier layer materials are described in the Liu et al. patent application discussed above.

Conductive material 160 is then formed over the substrate field 150 and within both the narrow feature definitions 120 and the wide feature definitions 130. The conductive material is deposited over the barrier layer 140. When the conductive material 160 is deposited, an overburden 170 over the narrow feature definitions 120 and a minimal overburden 180 over the wide feature definitions 130 are formed. The conductive material is typically copper containing materials, but it is to be understood that any suitable conductive material used in semiconductor manufacturing can be used. Examples of copper containing materials include copper, copper alloys (e.g. copper-based alloys containing at least about 80 weight percent copper) or doped copper.

After the conductive material 160 is formed over the substrate 100, it must be polished back to remove the excess conductive material 160. Prior to polishing, the substrate should be cleaned and buffed. The substrate 100 is first rinsed with deionized water to clean the substrate. The substrate 100 is then buffed.

Buffing the substrate involves placing the substrate 100 on a polishing head overlying a polishing pad on a platen. Deionized water is then provided between the substrate 100 and the pad while both the substrate 100 and the pad rotate. In one embodiment, the substrate 100 and the polishing pad are rotated in opposite directions at about 70 RPM to about 100 RPM. In another embodiment, the substrate 100 and the polishing pad are rotated in opposite directions at about 75 RPM to about 85 RPM. At less than about 70 RPM, hillocks will still form on the conductive material 160 during polishing. At greater than about 100 RPM, the topography of the substrate 100 can be negatively impacted. Additionally, at greater than about 100 RPM, the deionized water will not stay on the polishing pad sufficiently to perform the buffing process.

While the substrate 100 and the polishing pad are rotating, the substrate 100 may also sweep across the polishing pad. If so, the substrate 100 will sweep across the polishing pad in a sinusoidal pattern and cover about 1 inch to about 2 inches along the radial direction of the polishing pad. The substrate 100 will move through about 8 to about 12 sinusoidal patterns per minute.

The buffing can occur for a time period of about 10 seconds to about 60 seconds, with 30 seconds being most preferred. When the buffing is for less then 10 seconds, the buffing is not effective at suppressing hillock formation on the substrate during polishing. If the buffing is for greater than 60 seconds, then the topography of the substrate can be negatively impacted. Additionally, when buffing for greater than 60 seconds, the polishing pad life will not be as long.

In one embodiment, the downward pressure between the substrate and the polishing pad during buffing is about 0.5 psi and about 0.9 psi. In another embodiment, the downward pressure is about 0.6 psi to about 0.8 psi. The downward pressure, along with the rotation rate and de-ionized water, will help suppress hillock formation during the polishing steps.

The polishing pad can be a fully conductive polishing pad or a dielectric polishing pad. Examples of material that can be used include tin and polyurethane. Examples of polishing article assemblies that may be adapted to benefit from the invention are described in U.S. Pat. No. 6,991,528, issued Jan. 31, 2006, and United States Patent Publication No. 2004/0020789 A1, published Feb. 5, 2004, both of which are hereby incorporated by reference in their entireties.

Following the buffing, the polishing can proceed. The polishing should be performed on a different polishing pad than the buffing. A passivation layer 190 will be formed when a polishing composition is provided to the substrate 100 between the substrate 100 and a conductive polishing article 105. While an ECMP technique will be described, it is to be understood that the process is equally applicable to all CMP processes.

The polishing is a two-step process. During the first polishing step, a majority of the excess conductive layer will be removed. The first polishing step is performed with a first downward pressure of about 0.4 psi to about 0.6 psi, with 0.5 psi being most preferred. During the first polishing step, a DC power of about 2.5 volts is applied to the polishing pad. The polishing pad, which is located on a platen, is rotated at about 7 RPM to about 20 RPM. At rotation rates of greater than about 20 RPM, the polishing slurry will not stay evenly distributed across the polishing pad. At rotation rates less than about 7 RPM, the polishing will not be efficient.

The polishing slurry can have a surfactant added to it. Suitable surfactants contain a carboxylic acid functional group. Any conventional polishing slurry can be used to practice the invention. Particularly suitable polishing slurries are described in the Liu et al. patent application discussed above.

During the polishing, the substrate is also rotated. The substrate, which is located on the polishing head, is rotated at about 7 RPM to about 20 RPM. Similar to the platen rotation, rotation rates of greater than about 20 RPM, the polishing slurry will not stay evenly distributed across the polishing pad. At rotation rates less than about 7 RPM, the polishing will not be efficient. The first polishing step will last about 50 seconds to about 150 seconds.

FIG. 2B shows the conductive polishing article 105 coming into contact with the substrate 100 during the first polishing step. As the polishing progresses, the passivation layer 190 is slowly removed as is the conductive material 160. A slurry pocket 195 forms in valleys formed between the passivation layer 190 and the conductive polishing article 105 as is shown in FIG. 2C.

FIG. 2D shows the substrate 100 after the first polishing step. A protrusion 165 is present over the wide feature definition 130. The protrusion is purposely formed in order to prevent dishing. Additional conductive material 160 remains over the substrate field 150. The additional conductive material 160 over the substrate field 150 will be removed in the second polishing step. As can be seen from FIG. 2D, no hillocks are present on the partially polished conductive material 160. The only protrusion present is the protrusion 165 that was purposely formed to prevent dishing as described in the Liu et al. patent application discussed above No undesired hillocks are present.

During the second polishing step, both the polishing pad and the substrate 100 will be rotated. The polishing pad and the substrate will both be rotated at about 7 RPM to about 20 RPM, with 7 RPM being most preferred. The second polishing step will last about 50 seconds to about 200 seconds. A DC power of about 2.5 volts is applied to the polishing pad. The downward pressure for the second polishing step will be about 0.2 psi to about 0.4 psi, with 0.3 psi being most preferred. Generally, the conditions for the second polishing step are the same as for the first polishing step, except for the downward pressure. It is important for the second polishing step to have a lower downward pressure than the first downward pressure because the second polishing step will proceed at a slower rate. The first polishing step is focused on removing a lot of material in a quick manner. The second polishing step removes only a certain amount of material (i.e., the conductive material 160 and the barrier layer 140 overlying the substrate field 150). If the second polishing step is to have any control over removing material from the substrate 100, then the downward pressure for the second polishing step must be lower than the downward pressure in the first polishing step.

As the second polishing step progresses, the conductive material 160 will be removed from the substrate field 150 and the protrusion 165 will now be smaller and overlie the wide feature dimensions 130 (see FIG. 2E). Again, there are still no hillocks formed on the structure.

Once the second polishing step is completed, the semiconductor substrate 100 has been fully planarized as shown in FIG. 2F. The protrusion 165 has been removed and no hillocks are formed on the surface and no valleys are formed into the substrate or features. The barrier layer 140 has been removed over the substrate field 150 so that the wide feature dimensions 130 and the narrow feature dimensions 120 have been filled with conductive material 160.

If the substrate 100 is not cleaned and buffed prior to polishing, then undesirable hillocks will form on the substrate 100 during the polishing. By cleaning and buffing the substrate prior to polishing, hillock formation can be suppressed and a uniformly planarized substrate can be formed. Cleaning and buffing prior to polishing will not adversely affect protrusions that are purposefully formed to prevent dishing.

While the foregoing is directed to embodiments of the present invention, other and further embodiments of the invention may be devised without departing from the basic scope thereof, and the scope thereof is determined by the claims that follow.

We claim:

1. A polishing method that suppresses hillock formation on a substrate comprising:
buffing the substrate, wherein the buffing comprises
contacting the substrate with a polishing pad,
rotating the substrate, and
rotating the polishing pad, wherein the polishing pad and the substrate are rotated in opposite directions; and
electrochemical mechanical polishing the buffed substrate.

2. The method of claim 1, wherein said buffing is performed for about 10 seconds to about 60 seconds.

3. The method of claim 1, wherein said buffing is performed at a downward pressure between the polishing pad and the substrate of about 0.5 psi to about 0.9 psi.

4. The method of claim 1, wherein the polishing pad and the substrate each rotate at about 75 RPM to about 85 RPM.

5. The method of claim 1, further comprising providing deionized water between the substrate and the polishing pad during the buffing.

6. The method of claim 1, wherein the substrate has features formed therein and wherein the electrochemical mechanical polishing comprises:
polishing the substrate at a first downward pressure between the substrate and a polishing pad to form a protrusion over a feature of the substrate; and
polishing the substrate at a second downward pressure between the substrate and the polishing pad to produce a smooth substrate surface, wherein the first downward pressure is greater than the second downward pressure.

7. The method of claim 6, wherein the first downward pressure is about 0.4 psi to about 0.6 psi and the second downward pressure is about 0.2 psi to about 0.4 psi.

8. The method of claim 6, further comprising providing an electrolyte and a surfactant between the substrate and the polishing pad during the polishing.

9. The method of claim 6, wherein the polishing occurs with a different polishing pad than the buffing.

10. The method of claim 1, further comprising moving the substrate across the polishing pad while the polishing pad and the substrate both rotate.

11. A polishing method that suppresses hillock formation on a substrate comprising:
buffing the substrate, wherein the buffing comprises
contacting the substrate with a polishing pad,
rotating the substrate,
rotating the polishing pad, wherein the polishing pad and the substrate are rotated in opposite directions, and
moving the substrate across the polishing pad in a sinusoidal pattern while both the substrate and the polishing pad rotate; and
electrochemical mechanical polishing the buffed substrate.

12. The method of claim 11, wherein said buffing is performed for about 10 seconds to about 60 seconds.

13. The method of claim 11, wherein said buffing is performed at a downward pressure between the polishing pad and the substrate of about 0.5 psi to about 0.9 psi.

14. The method of claim 11, wherein the polishing pad and the substrate each rotate at about 75 RPM to about 85 RPM.

15. The method of claim 11, further comprising providing deionized water between the substrate and the polishing pad during the buffing.

16. The method of claim 11, wherein the substrate has features formed therein and wherein the electrochemical mechanical polishing comprises:
polishing the substrate at a first downward pressure between the substrate and a polishing pad to form a protrusion over a feature of the substrate; and
polishing the substrate at a second downward pressure between the substrate and the polishing pad to produce a smooth substrate surface, wherein the first downward pressure is greater than the second downward pressure.

17. The method of claim 16, wherein the first downward pressure is about 0.4 psi to about 0.6 psi and the second downward pressure is about 0.2 psi to about 0.4 psi.

18. The method of claim 16, further comprising providing an electrolyte and a surfactant between the substrate and the polishing pad during the polishing.

19. The method of claim 16, wherein the polishing occurs with a different polishing pad than the buffing.

20. A polishing method that suppresses hillock formation on a substrate comprising:
buffing the substrate, wherein the buffing comprises
contacting the substrate with a first polishing pad to create a downward pressure of about 0.5 psi to about 0.9 psi,
rotating the substrate at about 75 RPM to about 85 RPM,
rotating the first polishing pad at about 75 RPM to about 85 RPM, wherein the first polishing pad and the substrate are rotated in opposite directions,
providing deionized water between the substrate and the first polishing pad, and
moving the substrate across the first polishing pad in a sinusoidal pattern while both the substrate and the first polishing pad rotate; and
electrochemical mechanical polishing the buffed substrate, wherein the electrochemical mechanical polishing is performed using a second polishing pad.
